(19) United States
(12) Patent Application Publication
(10) Pub. No.: US 2026/0106893 A1
(43) Pub. Date: Apr. 16, 2026

(54) QUICK-RESPONSE CODE PHISHING DETECTION WITH IN-BROWSER REMEDIATION

(71) Applicant: Palo Alto Networks, Inc., Santa Clara, CA (US)

(72) Inventors: Shlomi Zrahia, Tel Aviv (IL); Ofer Ben-Noon, Tel Aviv (IL)

(21) Appl. No.: 18/916,498

(22) Filed: Oct. 15, 2024

(51) Int. Cl. H04L 9/40; G06F 16/955

(52) U.S. Cl. CPC H04L 63/1483; G06F 16/9554

(57) ABSTRACT

A web browser quick-response (QR) code filter (QR code filter) intercepts and scans Hypertext Transfer Protocol (HTTP) responses corresponding to web pages that are intended for a web browser. The QR code filter scans the HTTP responses for QR codes, and for each detected QR code, decodes the QR code to identify a uniform resource locator (URL) for the web page to which the QR code redirects. A rendering engine renders the web page corresponding to the URL in an isolated environment. The QR code filter then analyzes the rendering and additional characteristics of the QR code to determine whether the QR code is malicious and, for malicious QR codes, determines remediation actions to perform.

### BACKGROUND

The disclosure generally relates to transmission of digital information (e.g., CPC class H04L) and to arrangements for administration or management of switching networks (e.g., CPC subclass H04L 41/00).

Quick-response (QR) code phishing (“quishing”) is a malicious attack whereby an attacker attempts to dupe a user into navigating to a malicious website via a QR code and inputting sensitive data (e.g., personally identifiable information, login credentials, etc.). Susceptible users scan these malicious QR codes with mobile devices or other QR code-compatible devices and trust the websites where the QR codes redirect, due to falsely assuming trustworthiness of the original QR codes that navigated to the websites. Malicious QR codes are often presented in a context that appears legitimate so that users trust the QR codes and thus trust the websites to which they redirect.

### BRIEF DESCRIPTION OF THE DRAWINGS

Embodiments of the disclosure may be better understood by referencing the accompanying drawings.

FIG. 1 is a schematic diagram of an example system for detecting and performing remediation actions for malicious QR codes prior to those QR codes being rendered in a web browser.

FIG. 2 is an illustrative diagram of example web browser renderings for various remediation actions associated with detecting a malicious QR code in an initial web page.

FIG. 3 is a flowchart of example operations for detecting malicious QR codes in requested web pages at a web browser.

FIG. 4 is a flowchart of example operations for scanning Hypertext Transfer Protocol (HTTP) responses intended for a web browser to detect QR codes.

FIG. 5 is a flowchart of example operations for performing a remediation action(s) in a web browser based on characteristics of a malicious QR code.

FIG. 6 depicts an example computer system with a web browser-based QR code filter, a rendering engine, and a web browser.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Quishing attacks are common in web pages rendered in web browsers. Users will visit an initial web page, identify a QR code in the web page, scan the web page with a mobile device, and be redirected via the QR code to a malicious website. The malicious website then requests sensitive data (e.g., personally identifiable information, login data, etc.), and susceptible users will trust the QR code based on trusting the initial web page where it was embedded (e.g., in an email designed to look trustworthy). Once this trust is established, users will readily input their sensitive data to be received by a malicious actor. Intercepting and cleansing web pages of malicious QR codes prior to rendering the QR codes in a web browser circumvents the level of trust susceptible users place in (apparently trustworthy) web pages and allows for proper remediation of malicious QR codes.

The present disclosure proposes a web browser-based QR code filter (QR code filter) that, prior to rendering web pages in a web browser, scans the web pages for images. Based on detecting images, the QR code filter analyzes the images across web pages to identify/detect any QR codes therein. When a QR code is identified, the QR code filter decodes the QR code using optical character recognition (OCR) to obtain a uniform resource locator (URL) for a redirect web page where the QR code redirects. A rendering engine receives the URL from the QR code filter and renders the redirect web page for the URL along with any additional redirects in the redirect web page in an isolated environment. The QR code filter then combines security analysis of the URL, characteristics of the redirect web page and the rendering of the redirect web page, and characteristics of the additional redirect web pages and their renderings to determine whether the QR code is malicious.

Based on determining the QR code is benign, the QR code filter renders the initial web page where the QR code was identified and allows for redirection via the QR code (e.g., by rendering the QR code image so that a user can scan the QR code image with their phone, replacing the QR code with the corresponding URL, etc.). Based on determining the QR code is malicious, the QR code filter performs a variety of remediation actions that depend on severity of maliciousness and configurable settings. The remediation actions include rendering the initial web page with the QR code masked, rendering the redirect web page in a remote browser isolation environment or other browser environment that prevents file uploads/downloads, script executions, and disables login features, etc. The QR code filter can additionally generate alerts to the user that an unusual or malicious QR code was detected. Using the QR code filter drastically reduces the likelihood of quishing attacks by acting as an intermediary between the user and the web browser, thereby gaining user trust by warning users of potentially malicious QR codes before any subsequent attack occurs. Moreover, the variety of remediation actions to choose from based on severity of maliciousness allows for continued browsing without outright blocking web pages with QR codes. Finally, in-browser remediation of QR codes reduces the chances that a user will switch between devices (e.g., from an endpoint device to a mobile device), which in turn reduces the security risk associated with using multiple devices that may or may not be protected by the same security systems within an organization.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

For clarity and conciseness, a web page requested by a web browser that (potentially) includes a QR code is referred to as an “initial” web page, a web page to which the QR code redirects is a “redirect” web page, and web pages to which the redirect web page redirects are referred to as “additional” web pages. The additional web pages can alternatively be referred to as “downstream redirects” or “cascading redirects”.

### Example Illustrations

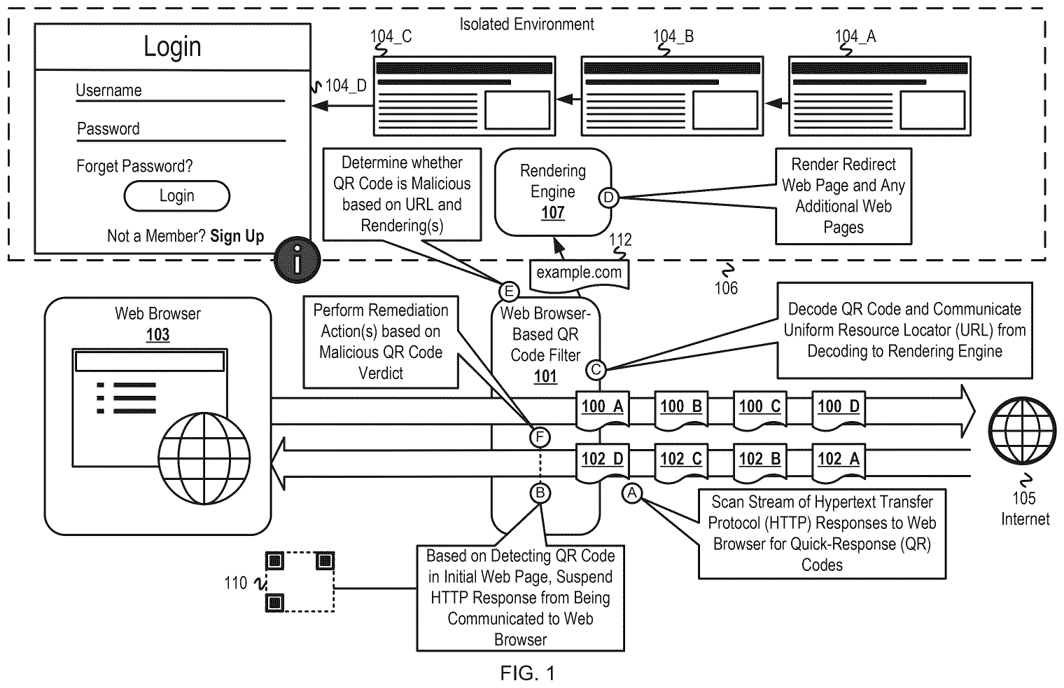

FIG. 1 is a schematic diagram of an example system for detecting and performing remediation actions for malicious QR codes prior to those QR codes being rendered in a web browser. A web browser-based QR code filter (“QR code filter”) 101 is an intermediary between a web browser 103 and the Internet 105. The QR code filter 101 monitors Hypertext Transfer Protocol (HTTP) requests from the web browser 103 to web servers for websites over the Internet 105 and corresponding HTTP responses from the Internet 105 to the web browser 103. For the purposes of QR code detection, the QR code filter 101 intercepts/obtains HTTP responses before they are received by the web browser 103 and corresponding initial web pages are rendered. The QR code filter 101 identifies images in the intercepted HTTP responses and uses image detection to detect any QR codes therein.

If a QR code is detected in an intercepted HTTP response for an initial web page, the QR code filter 101 decodes the QR code with OCR to obtain a URL of a redirect web page to which the QR code redirects. The QR code filter 101 then communicates the URL to a rendering engine 107 running in an isolated environment 106. The rendering engine 107 obtains an HTTP response from the redirect web page for the URL via the Internet 105 and renders the HTTP response. While rendering the HTTP response, the rendering engine 107 determines whether there are any additional redirects in the redirect web page (e.g., via an evasion attack or URL redirection attack) to additional web pages. If present, the rendering engine 107 also obtains HTTP responses for those additional web pages and renders those HTTP responses. The QR code filter 101 then analyzes the renderings by the rendering engine 107 and characteristics of the redirect web page from both a security and a data loss prevention (DLP) perspective to determine whether the QR code is malicious. If the QR code is benign, the QR code filter 101 communicates the initial web page to the web browser 103 for rendering. Otherwise, the QR code filter 101 performs a remediation action based on the malicious QR code, such as masking the QR code, removing the QR code, replacing the QR code with its URL or a preview of the redirect web page, loading the redirect web page in an isolated environment, etc.

FIG. 1 is annotated with a series of letters A-F identifying stages of operations. Each stage represents one or more operations. Although these stages are ordered for this example, the stages illustrate one example to aid in understanding this disclosure and should not be used to limit the claims. Subject matter falling within the scope of the claims can vary from what is illustrated.

At stage A, the QR code filter 101 scans a stream of HTTP responses to the web browser 103 for QR codes. In the depicted example, the QR code filter 101 is scanning HTTP responses 102A-D sent by a web server in response to HTTP requests 100A-D, respectively, and these HTTP responses are assumed to be for a same session of the web browser 103. The scanning of HTTP responses occurs in two stages for each HTTP response—at a first stage, the QR code filter 101 determines if there is image data in the HTTP response. If there is image data, at a second stage the image data is analyzed with image detection and OCR to determine whether there is a QR code(s) in the HTTP response. For the first stage, the QR code filter 101 can determine whether the HTTP response has a Content-Type header field with value “image/*”, an image Hypertext Markup Language (HTML) element, etc. For the second stage, the QR code filter 101 applies image detection to determine whether the image data comprises a QR code. The image detection can be performed with any image/object detection algorithm or model trained, tuned, or otherwise modified to detect QR codes (e.g., neural networks, large language models, etc.). In some embodiments, the QR code filter 101 can stitch image data across multiple images to determine whether the stitched image data is a QR code. For instance, the QR code filter 101 can rearrange various subsets of images across the multiple images to determine whether a rearranged subset of images makes up a QR code.

The example in FIG. 1 assumes that HTTP responses 102A-D were returned by a web server on the Internet 105 in response to the web browser 103 communicating HTTP requests 100_A-D, respectively. The QR code filter 101 (or other cybersecurity component) can perform additional security operations on the HTTP requests 100_A-D prior to communicating them to the Internet 105 (e.g., to determine whether any URL(s) indicated therein matches a URL in a database of malicious URLs, whether any signatures of the HTTP responses 102_A-D match signatures of known malicious HTTP requests, etc.).

While filtering HTTP responses that have malicious QR codes, the QR code filter 101 sorts the HTTP responses according to their respective sessions. This allows the QR code filter 101 to suspend HTTP responses within each session while a QR code is being analyzed for maliciousness. The operations for queueing HTTP responses according to their corresponding sessions for detecting QR codes can be implemented in tandem with other operations for analyzing HTTP responses for maliciousness within each queue.

The QR code filter 101 can be implemented as an extension of the web browser 103, as HTTP middleware, as a tool integrated into a custom web browser (e.g., a web browser customized for the security policies and other preferences of an organization), etc. Moreover, the QR code filter 101/web browser 103 can be deployed in tandem with secure access service edge (SASE) services operating in the cloud, wherein the SASE services facilitate fast, secure access to the Internet across an organization from endpoint devices that can be geographically separated, while the QR code filter 101 and web browser 103 analyze user browsing data and allow for more granular control over web access based on specific content and/or behavioral data.

At stage B, based on detecting a QR code 110 in an initial web page (i.e., a web page for the HTTP request 100_D) the QR code filter suspends the HTTP response 102 D as well as additional HTTP responses 102_A-102_C from being communicated to the web browser 103 for rendering. For instance, the QR code filter 101 can store the HTTP responses 102_A-D in a cache or other data structure for temporary storage while analyzing the QR code 110 for maliciousness. Depending on the type of deployment for the QR code filter 101 (e.g., as middleware, a browser extension, a native tool implemented in a custom web browser, etc.), the cache or temporary data storage may occur at an endpoint device or in the cloud.

At stage C, the QR code filter 101 decodes the QR code 110 and communicates a URL from the decoding (URL 112 example.com in the depicted example), i.e., the URL to which the QR code 110 redirects, to the rendering engine 107. The QR code filter 101 uses OCR to obtain a bit string for the QR code 110 and applies error correction (e.g., Reed-Solomon error correction) to correct any incorrect bits. The QR code filter 101 then applies a QR code decoding algorithm (e.g., according to bit strings therein that indicate types of encoding for each section of the QR code 110) to decode the QR code. If the QR code filter 101 determines that the QR code 110 cannot be decoded due to incorrect syntax and/or does not decode as a URL, the QR code filter 101 can remove the QR code 110 (e.g., remove the corresponding image data) from the HTTP response 102_D and communicate the HTTP responses 102_A-D with the image data removed to the web browser 103 for rendering. In this case, the QR code filter 101 can additionally add a warning to the HTTP response 102_D (e.g., a warning at a location where the QR code 110 was embedded in the initial web page) that a defunct QR code was detected and removed.

At stage D, the rendering engine 107 renders the redirect web page corresponding to the URL 112 and renders any additional web pages to which the redirect web page redirects, e.g., as part of an evasion or URL redirection attack. Because the rendering engine 107 is running in an isolated environment 106 (e.g., a remote browser isolation environment), the rendering engine 107 can block any attempts by the redirect web page to upload or download data to and from the Internet 105 and/or execute scripts and can log these attempts to include as metadata/characteristics alongside the renderings for maliciousness analysis. The rendering engine 107 can identify 301 or 302 HTTP response codes to detect a redirect(s) and can render web pages both before and after the redirect(s). For the depicted example, the redirect web page redirects to three additional web pages, and the four resulting web pages have renders 104_A-D, with rendering 104_D corresponding to a phishing login page. The rendering engine 107 communicates the renders 104_A-D and any additional metadata/characteristics logged during the rendering (e.g., attempted uploads, downloads, script executions, etc.) to the QR code filter 101.

The operations for rendering provided by the rendering engine 107 can be implemented by running the web browser 103 as a separate instance in a remote browser isolation environment or other computing environment that disables file downloads, script execution, attack surface components, login options, etc. In some instances, the rendering engine of the web browser 103 will be directly accessible as a separate tool by the QR code filter 101. For instance, the web browser 103 may be a custom web browser offered as a tool, and the QR code filter 101 can load this tool into the isolated environment 106.

At stage E, the QR code filter 101 determines whether the QR code 110 is malicious based on the URL 112, the renderings 104_A-D, and metadata/characteristics of the redirect web page. The QR code filter 101 determines whether the URL 112 matches a URL in a malicious URL database (e.g., by matching a top-level domain for a website of the URL 112). Additionally, the QR code filter 101 analyzes the renderings 104 A-D and metadata/characteristics for malicious content, sensitive data, and/or malicious behavior related to uploads, downloads, and script executions. The QR code filter 101 can implement cybersecurity modules for analyzing scripts for maliciousness, determining and analyzing the content to be uploaded and/or downloaded, and analyzing data in the renderings 104_A-D (e.g., using OCR), and DLP modules to identify sensitive data/sensitive data types to determine whether the QR code 110 is malicious. The QR code filter 101 collects data associated with this analysis such as entity types that were exposed as sensitive data during DLP analysis, attack type, severity, associated vulnerabilities, Common Vulnerability Scoring System (CVSS) scores, etc. This data is then used for determining a remediation action to perform based on detecting a malicious QR code.

The QR code filter 101 can additionally use characteristics of the initial web page corresponding to the HTTP response 102_D when determining whether the QR code 110 is malicious. Any of the aforementioned renderings and DLP/security analyses can be performed for the initial web page and scores can be assigned accordingly and combined with scores for the redirect web page.

At stage F, the QR code filter 101 determines whether the QR code 110 is malicious. If the QR code filter 101 determines that the QR code 110 is benign, the QR code filter 101 communicates the HTTP responses 102_A-D to the web browser 103 for subsequent rendering without modification or with an indication that a QR code was detected. If the QR code filter 101 determines that the QR code 110 is malicious, the QR code 110 evaluates remediation criteria to determine any remediation actions to perform as a result and performs those remediation actions.

Example remediation actions include masking the QR code 110 (i.e., replacing the QR code 110 with a black image of the same size) but keeping the image data for the QR code 110 in the HTTP response 102_D, removing the QR code 110 entirely, presenting a preview of the redirect web page based on a mouse hovering over the QR code 110, replacing the QR code 110 with the URL 112, and/or forcing the redirect web page to load in an isolated environment (e.g., a remote browser isolation environment or other custom isolated environment for web page rendering). The choice of remediation action is based on results of the maliciousness analysis and can depend on configurable settings by an organization that implements the web browser 103 and the QR code filter 101. For instance, for a high-severity QR code (e.g., according to CVSS scores of detected attacks, highly sensitive data detected for DLP, etc.), the QR code filter 101 can be configured to completely remove the QR code 110 and generate an alert indicating the removal and characteristics of maliciousness that led to the removal (e.g., attack type, attack vector, etc.). For a medium-severity QR code, the QR code filter 101 can instruct the web browser 103 to display a preview of the redirect web page when hovering over the QR code 110 with a warning stating that the URL 112 may compromise browser security. The QR code filter 101 may additionally instruct the web browser 103 to load the redirect web page in an isolated environment if a user navigates to the URL 112. For a low-severity QR code, the QR code filter 101 can replace the QR code 110 with the URL 112 and instruct the web browser 103 to generate a warning that the URL 112 was obtained from a QR code and may navigate to malicious content. The latter low-severity remediation action avoids a user of the web browser 103 loading the QR code 110 on a mobile device.

The web browser 103 can be configured to apply remediation actions based on instructions from the QR code filter 101, e.g., when the web browser 103 is a custom web browser for an organization. For instance, rather than the QR code filter 101 altering HTTP responses so that when a mouse hovers over a QR code the redirect web page is displayed as a preview (e.g., according to the rendering obtained by the QR code filter 101), the QR code filter 101 can instead communicate an indication of the location of the QR code and an identifier of the remediation action, and the web browser 103 can be configured to automatically apply the indicated remediation action accordingly when rendering the HTTP responses.

As the QR code filter 101 detects and performs remediation actions for malicious QR codes, the QR code filter 101 can maintain a database (not depicted) of QR codes and their associated trustworthiness using historical data for the associated URL/web page, threat intelligence feeds, etc. The database can store each QR code (e.g., as an image file) in association with the type of malicious attack for the URL to which the QR code redirects, a severity score of the attack (e.g., according to severity scores indicated in threat intelligence feeds), etc.

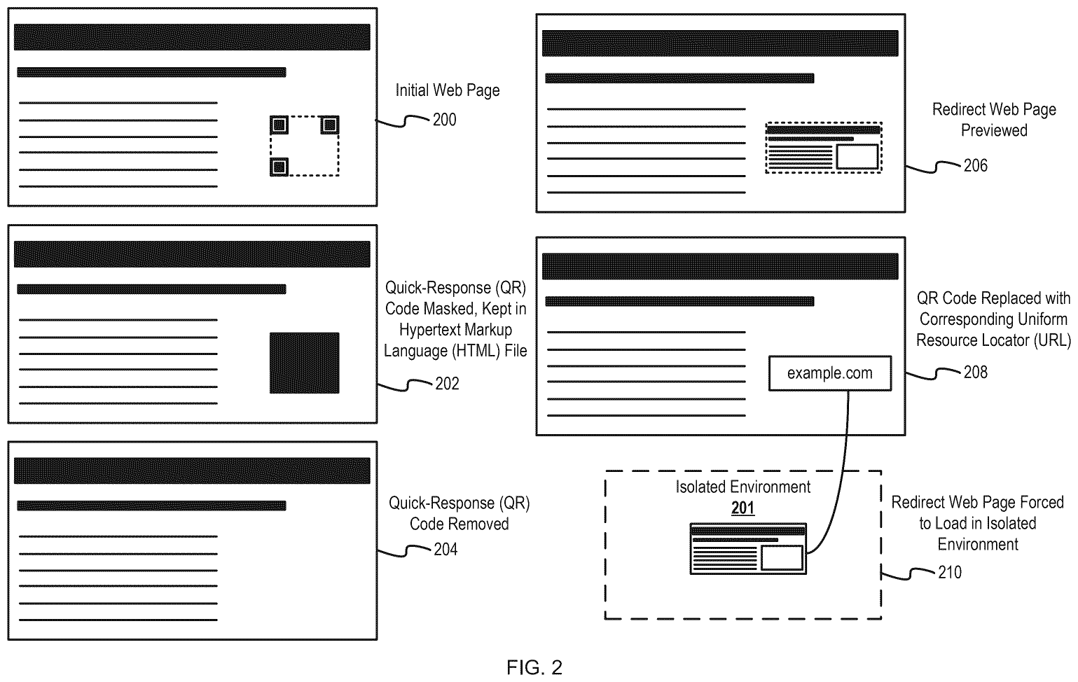

FIG. 2 is an illustrative diagram of example web browser renders for various remediation actions associated with detecting a malicious QR code in an initial web page. A rendering 200 of an initial web page comprises a QR code. A rendering 202 comprises a rendering of the initial web page with the QR code masked by a black image, wherein image data for the QR code remains in the corresponding HTTP response/HTML file. A rendering 204 comprises a rendering of the initial web page with the QR code entirely removed, including any image data from the corresponding HTTP response. A rendering 206 comprises a rendering of the initial web page with the QR code replaced by a preview of the redirect web page to which the QR code redirects. The preview of the redirect web page can comprise a preview obtained using an expected user agent (e.g., a user agent of a mobile device). A rendering 208 comprises a rendering of the initial web page with the QR code replaced by the corresponding URL “example.com” to which the QR code redirects. Example 210 illustrates an isolated environment 201 and a rendering of the redirect web page therein, wherein a web browser forced the redirect web page to load in the isolated environment.

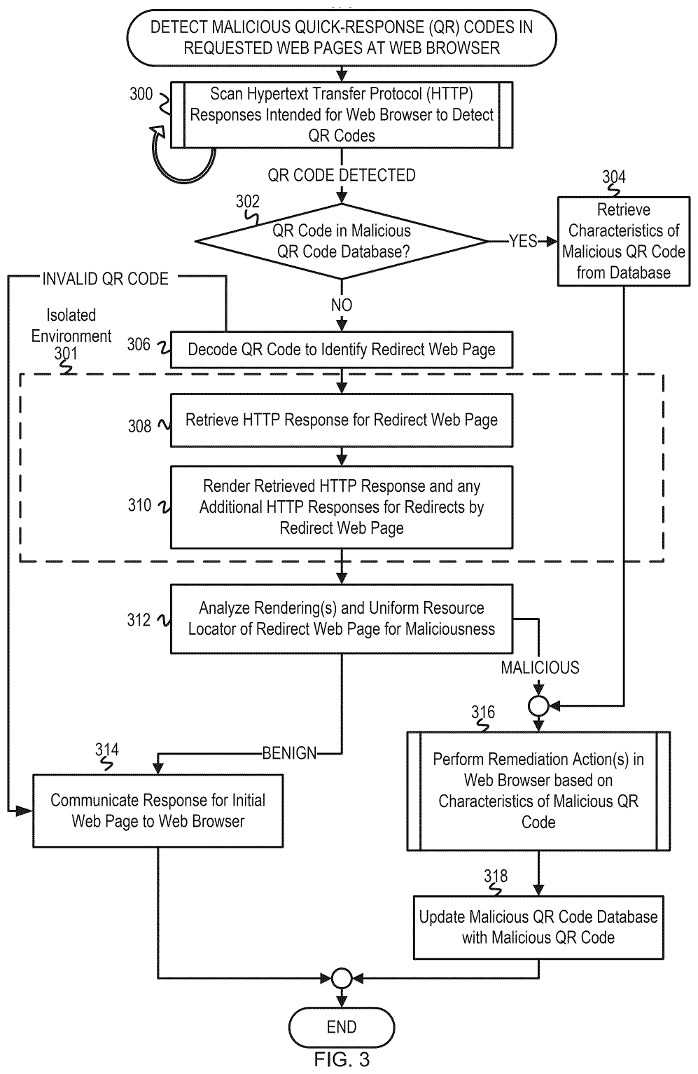

FIGS. 3-5 are flowcharts of example operations for detecting malicious QR codes in requested pages at a web browser using various scanning, rendering, and security/DLP techniques. The example operations are described with reference to a QR code filter, a rendering engine, and a web browser for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

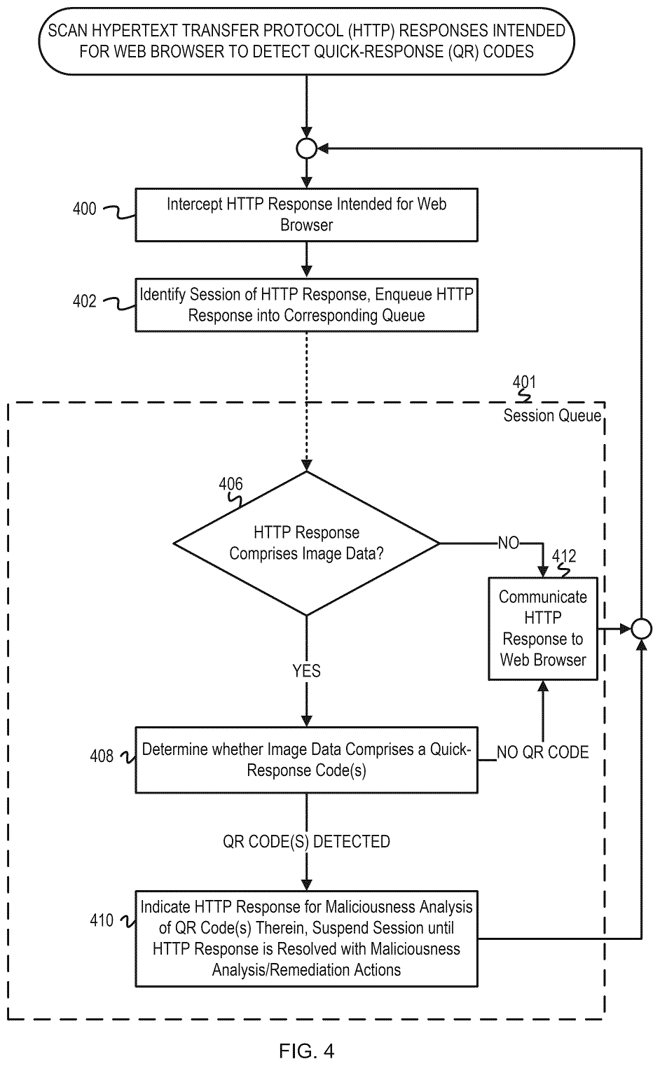

FIG. 3 is a flowchart of example operations for detecting malicious QR codes in requested web pages at a web browser. At block 300, a QR code filter scans HTTP responses intended for a web browser to detect QR codes. The QR code filter scans the responses by first detecting image data (e.g., image HTML elements) in the responses and then applying image/object detection to the image data to determine whether the image data comprises QR codes. Once a QR code is detected in an HTTP response for an initial web page, the QR code filter suspends a corresponding session for that HTTP response until the QR code is resolved via maliciousness analysis and/or remediation actions. In some embodiments, an administrator or other entity managing the QR code filter and the web browser may instruct the QR code filter to only scan a subset of HTTP responses. For instance, an administrator may only scan “unknown” websites according to a database of known benign or malicious websites maintained by a corresponding organization. Additionally or alternatively, the HTTP responses can be scanned only for specific types of websites (e.g., social media websites, gambling websites, etc.) according to a custom policy. The operations at block 300 are described in greater detail in reference to FIG. 4. If a QR code is detected, operational flow proceeds to block 302. Otherwise, operational flow continues at block 300 to continue scanning responses for QR codes.

At block 302, the QR code filter determines whether the detected QR code is present in a malicious QR code database (database). The database comprises identifiers of QR codes (e.g., the QR codes themselves, hash values of bit strings for the QR codes, etc.) stored in association with their characteristics (e.g., severity scores, whether sensitive data was present, types of malicious attacks, etc. for redirect web pages). The QR code filter queries the database with an identifier of the detected QR code. If the database returns an indication that the QR code was present, the QR code is determined to be malicious and operational flow proceeds to block 304. Otherwise, operational flow proceeds to block 306.

At block 304, the QR code filter retrieves characteristics of the malicious QR code from the database. For instance, the QR code filter can retrieve the characteristics from a response to the QR code filter querying the database. Operational flow proceeds to block 316.

At block 306, the QR code filter decodes the QR code to identify a redirect web page. The QR code filter first uses OCR to obtain a bit string for the QR code. Then, the QR code filter performs error correction (e.g., using Reed-Solomon error correction) to correct any bit errors in the QR code. The QR code is encoded with various encoding algorithms (e.g., numeric encoding, byte encoding, etc.) according to character formats in the corresponding URL; each encoded section of the QR code is decoded according to modes indicated in the QR encoding that indicate each type of encoding and where that type occurs. The QR code filter can then validate the URL by determining whether the URL has the correct syntax for a URL. If the URL is invalid, the QR code filter can remove the QR code from the HTTP response and add an indication that there was an invalid QR code in the HTTP response. Alternatively, the QR code filter can include the QR code in the HTTP response with an indication that the QR code does not correspond to a valid URL. More generally, the QR code filter can support QR codes having different types of uniform resource identifiers (URIs) and can indicate if the QR code does not have a valid URI of one of those types. If the QR code does not have a valid URL, operational flow proceeds to block 314.

The operations at blocks 308 and 310 occur in an isolated environment 301 so that any rendering operations by a rendering engine are not exposed to malicious attacks or exposure over the Internet.

At block 308, the rendering engine (or separate networking component that manages the isolated environment 301) retrieves an HTTP response for the redirect web page. The rendering engine communicates an HTTP request to the URL of the redirect web page over the Internet and receives the HTTP response.

At block 310, the rendering engine renders the retrieved HTTP response and any additional HTTP responses for redirects by the redirect web page. During the process of rendering the redirect web page, the rendering engine may determine that the redirect web page is attempting to download, upload, and/or execute scripts. The isolated environment 301 serves as guardrails so that attempted uploads, downloads, and/or script executions by the redirect web page do not occur. The rendering engine can additionally log these attempted uploads/downloads/script executions as characteristics of the QR code for subsequent maliciousness analysis. The rendering engine determines whether any additional redirects occur from the redirect web page during rendering (e.g., by identifying any 301 or 302 response status codes in the HTTP response) and can render the additional web pages from these additional redirects as well for subsequent maliciousness analysis.

At block 312 (potentially outside of the isolated environment, although this may vary by implementations), the QR code filter analyzes the rendering(s) and the URL of the redirect web page for maliciousness. The QR code filter can comprise a DLP component (e.g., an off-the-shelf DLP component) that identifies potentially sensitive entities in the web page renderings and flags these entities as potentially sensitive data. The QR code filter can generate signatures for the source HTML code and the rendering(s) of the redirect web page and any additional web pages and match the signatures with signatures of known malicious web pages. Similarly, the QR code filter can generate signatures for scripts that were attempted to be executed during rendering and compare the generated signatures to signatures of known malicious scripts. The maliciousness analysis additionally assesses severity when malicious characteristics of the QR code are identified, for instance, according to severity of attacks corresponding to scripts/signatures, according to security levels or other sensitivity metrics of identified sensitive data, according to URL matches against a database of known malicious URLs and corresponding severities/known malicious attacks, etc. The QR code filter can additionally analyze the initial web page and a corresponding HTTP response where the QR code was detected for characteristics using the same DLP/security analysis techniques. Moreover, the initial web page can also be rendered in an isolated environment for this purpose. These characteristics can be used for determining the subsequent criteria for maliciousness.

Criteria for maliciousness can be based on a combined score of maliciousness from both DLP and security analysis and/or based on criteria applied to each of the DLP analysis and the security analysis. For instance, if the DLP analysis or security analysis yield a score below a corresponding threshold score (with a higher score indicating more security and less sensitive data), the QR code can be determined to be malicious. For the DLP analysis, the criteria can instead be whether the redirect web page and/or additional web page comprise sensitive data. Alternatively, if the combined (e.g., summed) score from DLP analysis and security analysis is below a threshold score, then the QR code can be determined to be malicious. If the redirect web page (and, thus, the QR code) is determined to be malicious, operational flow proceeds to block 316. Otherwise, operational flow proceeds to block 314.

At block 314, the QR code filter communicates the response for the initial web page to the web browser. In some implementations, for ease of browsing, the initial web page can additionally or alternatively include the URL of the QR code so that the QR code may be accessed in-browser rather than via a mobile device or other QR code-compatible device. The operational flow in FIG. 3 terminates after block 314.

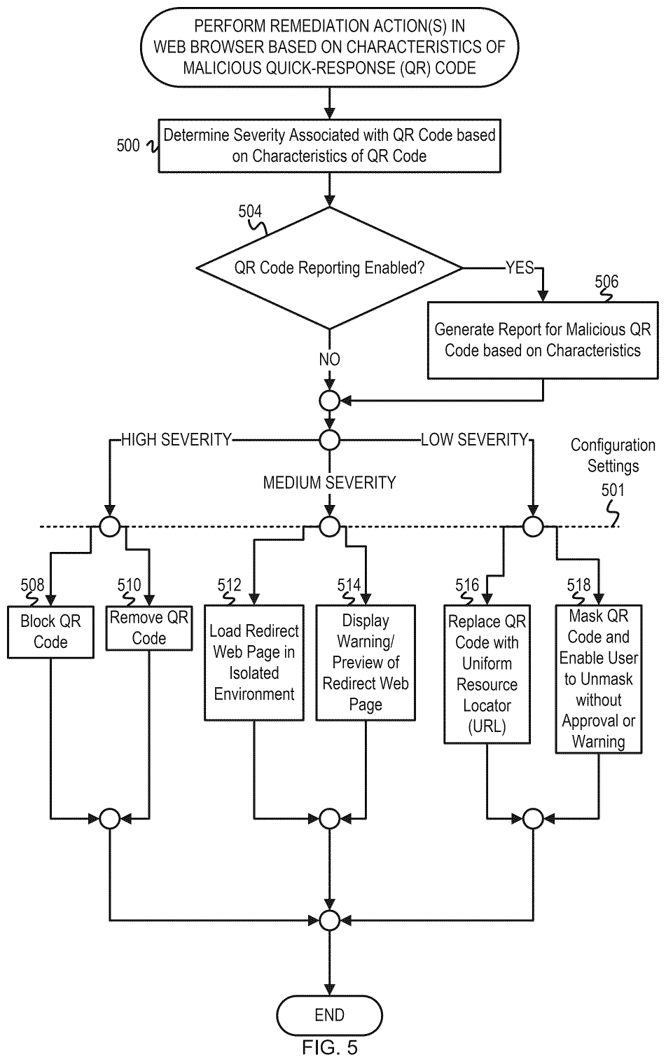

If a maliciousness determination was made (block 304 or block 312), then the QR code filter and/or web browser performs a remediation action(s) in the web browser based on characteristics of the malicious QR code at block 316. The remediation action(s) is performed for the initial web page and, in some instances, when the redirect web page is subsequently requested at the web browser. The component modifying the initial web page and/or redirect web page can vary between the QR code filter and the web browser by implementation. In some implementations, the QR code filter can simply indicate the type of remediation action to be performed to the web browser and the web browser can perform remediation action accordingly. In other implementations, the QR code filter can modify the HTTP response(s) for the initial and/or redirect web page according to the remediation action(s) (e.g., by removing the QR code and adding a warning that the QR code was removed) and communicate the modified HTTP response(s) to the web browser, and the web browser can render the HTTP responses(s) without additional operations. Certain remediation actions may have operations that can only be performed in the web browser, for instance remediation actions for previewing the redirect web page when a mouse hovers over the QR code in the initial web page. The operations at block 316 are described in greater detail in reference to FIG. 5. FIG. 5 refers to a web browser as performing each of the described remediation actions for simplicity. As noted above, many of these remediation actions can be partially or wholly performed by the QR code filter.

Subsequent to the operations at block 314 or 316, the QR code filter resumes the session corresponding to the HTTP response for the initial web page that was suspended when the QR code was detected at block 300. The web browser can then process any additional HTTP responses that were queued during the suspension.

At block 318, the QR code filter updates a malicious QR code database with the malicious QR code. The malicious QR code database additionally stores characteristics of the malicious QR code such as associated cybersecurity attacks, severity scores, sensitive data types and severities, vulnerabilities exposed by the cybersecurity attacks and their severities, etc. These characteristics are used when the malicious QR codes are subsequently detected to determine the remediation action(s) to perform accordingly.

FIG. 4 is a flowchart of example operations for scanning HTTP responses intended for a web browser to detect QR codes. The operations in FIG. 4 are depicted in a closed loop as HTTP responses intended for the web browser are intercepted and analyzed by a QR code filter. The example operations can be suspended or terminated when the QR code filter is no longer enabled according to an organizational policy (e.g., for a custom web browser of the organization).

At block 400, the QR code filter intercepts an HTTP response intended for a web browser. The QR code filter acts as an interface between the web browser and the Internet by analyzing browsing behavior of the web browser and web pages/websites accessed thereof to block or otherwise mitigate malicious content communicated from the Internet. Implementations of the QR code filter can vary; for instance, the QR code filter can be implemented as a browser extension of the web browser, as a tool of the web browser when the web browser is a custom web browser, as middleware between the web browser and the Internet (e.g., using an HTTP interceptor), etc. Moreover, the QR code filter can be a sub-module of a larger interface between the web browser and the Internet that analyzes HTTP requests and HTTP responses for additional attack vectors than QR codes.

At block 402, the QR code filter identifies a session of the HTTP response and enqueues the HTTP response into a corresponding queue. The example operations are described using queues to group HTTP responses for each session for simplicity of illustration. Any data structure and/or type of processing across sessions of the web browser can be implemented so that QR codes are detected within each session; said data structure and/or type of processing thus supports suspension of sessions when a QR code is detected, until that QR code is resolved. The subsequent operations in FIG. 4 occur for a session queue 401 corresponding to the session identified for the HTTP response. The connector between blocks 402 and 406 is depicted with a dotted line to indicate the distinction between the operations at block 400, 402 which occur across all session queues, and the operations at the remaining blocks that occur within the session queue 401.

At block 406, the QR code filter scans the HTTP response for image data. For instance, the QR code filter can identify image HTML elements, identify that the HTTP response has a Content-Type header field with value “image/*” (for a valid image data format “*”), etc. If the QR code filter determines that the HTTP response comprises image data, operational flow proceeds to block 408. Otherwise, operational flow proceeds to block 412.

At block 408, the QR code filter determines whether image data in the HTTP response comprises a QR code(s). For instance, the QR code filter can use a third-party (e.g., open source) software tool for OCR or other types of image detection for QR code identification. If the image data comprises a QR code(s), operational flow proceeds to block 410. Otherwise, operational flow proceeds to block 412.

At block 410, the QR code filter indicates the HTTP response for maliciousness analysis of the QR code(s) therein and suspends the session for the session queue 401 (e.g., by enqueuing subsequent HTTP responses into the session queue 401 without dequeuing the HTTP responses) until the HTTP response is resolved with maliciousness analysis and, for a malicious HTTP response, the maliciousness is optionally resolved with a remediation action(s) (e.g., according to the operations depicted in FIG. 3). Operational flow returns to block 400 for intercepting and enqueuing additional HTTP responses according to their respective sessions. During the time period for resolution of the HTTP response, additional HTTP responses for the corresponding session may be delayed.

At block 412, the QR code filter communicates the HTTP response to the web browser for subsequent rendering. The HTTP response is then dequeued from the session queue 401 (or other data structure used to organize HTTP responses by their respective sessions). Operational flow returns to block 400.

FIG. 5 is a flowchart of example operations for performing a remediation action(s) in a web browser based on characteristics of a malicious QR code. The operations in FIG. 5 assume that a QR code in an initial web page to be rendered in a web browser has been detected as malicious according to analysis from both a security perspective and a DLP perspective, e.g., according to the operations depicted in FIG. 3. The analysis yields additional characteristics of the QR code such as attempted uploads/downloads/script executions, identified sensitive data and its importance within an organization, type and severity of any detected cybersecurity attacks, etc.

At block 500, the QR code filter determines a severity associated with a QR code based on characteristics of the QR code. The QR code filter applies heuristics to the characteristics to determine a severity (e.g., high-, medium-, or low-severity) that applies to the QR code. For instance, the heuristics can take a weighted summation of severity scores associated with detected malicious attacks and scores associated with importance of exposed sensitive data. The weighted summation can then be determined to be within a range for the corresponding severity.

At block 504, the QR code filter determines whether QR code reporting is enabled for an organization or other entity associated with the QR code filter. The organization or entity additionally has access to configuration settings 501 that determine types of remediation actions to perform based on corresponding severities in the foregoing. QR code reporting can be enabled to track QR codes for subsequent reputation analysis, for instance by maintaining a database of malicious QR codes and their corresponding characteristics/reputations. If QR code reporting is enabled, operational flow proceeds to block 506. Otherwise, operational flow proceeds to one of blocks 508, 510, 512, 514, 516, and 518 depending on the severity determined at block 500 and the configuration settings 501.

At block 506, the QR code filter generates a report for the malicious QR code based on the characteristics. The QR code filter can insert characteristics into corresponding fields in a template report that describes the malicious QR code, e.g., fields for attacks and attack type/severity score, a URL field, a sensitive data type/severity field, etc. Operational flow proceeds to one of blocks 508, 510, 512, 514, 516, and 518 depending on the severity determined at block 500 and the configuration settings 501.

Blocks 508 and 510 correspond to high severity, blocks 512 and 514 correspond to medium severity, and blocks 516 and 518 correspond to low severity. The configuration settings 501 determine whether, for low severity, operations at block 508 or 510 occur, for medium severity, operations at block 512 or 514 occur, and for high severity, operations at block 516 or 518 occur, according to organizational preferences. Once the operations at block 508, 510, 512, 514, 516, or 518 occur, the operational flow in FIG. 5 is complete.

At block 508, the web browser blocks the QR code. Blocking the QR code comprises replacing the QR code in the HTTP response for the initial web page with an indication that the QR code was blocked and optionally characteristics of the QR code that are explanatory as to why the URL was blocked such as attack types/severities, sensitive data types/severities, etc. The web browser then renders the initial web page with the modified HTTP response.

At block 510, the web browser removes the QR code from the initial web page. The web browser removes the corresponding image data (e.g., image HTML element) from an HTTP response for the initial web page prior to rendering the initial web page.

At block 512, the web browser configures the initial web page so that when a user clicks on or otherwise interacts with the QR code, the redirect web page is loaded into an isolated environment. The isolated environment can comprise a remote browser isolation environment or other isolated environment that disables uploads/downloads/script executions. The remote browser isolation environment can comprise a mode of the web browser itself or can be implemented via a third-party tool by loading the redirect web page into the third-party tool.

At block 514, the web browser modifies the initial web page so that when a mouse hovers over the QR code, a preview of the redirect web page by the QR code and/or a warning is displayed in the web browser. When generating the preview, the web browser can request an HTTP response from the redirect web page using a user agent that more accurately reflects what the user of the web browser will encounter when accessing the redirect web page via the web browser and/or a mobile device. The preview can be presented as a rendering of the redirect web page or a text summary of the redirect web page. The text summary can be generated using abstractive summarization of content in the redirect web page, by prompting a large language model to concisely summarize the redirect web page, etc.

At block 516, the web browser replaces the QR code with the URL of the redirect web page in the initial web page. The web browser can additionally add an indication that the URL is a URL for a redirect by a QR code.

At block 518, the web browser masks the QR code and enables the user to unmask the QR code without approval (e.g., administrator approval) or warning. To mask the QR code, the web browser replaces the QR code with a mask (e.g., a black image) during rendering, but maintains the original QR code in the corresponding HTTP response. This allows the web browser to subsequently display the QR code if the user selects the option to enable the QR code.

The foregoing remediation actions are provided as illustrative examples for varying severities of QR codes. Different embodiments can implement variations of these remediation actions and can assign different remediation actions to different severities. For instance, the operations at block 518 can be modified so that unmasking the QR code only occurs after a warning and/or administrator approval. The corresponding severity for this modified remediation action can be escalated to medium or high severity. Another variation of a remediation action is, in the web browser, instead of navigating to the redirect web page for the QR code, instead navigate to a web page controlled by the web browser that explains the risk associated with navigating to the redirect web page and/or provides a preview or text summary of the web page.

Although FIG. 5 indicates that one remediation action is performed for a malicious QR code, in some embodiments multiple remediation actions can be performed. For instance, a QR code can be masked with the option of unmasking without approval or warning (e.g., block 518), but also when the QR code is unmasked, the redirect web page for the QR code is loaded in an isolated environment (e.g., block 512). The severity corresponding to this combined remediation action can be escalated to medium. The configuration settings 501 can specify that multiple remediation actions may occur.

### Variations

Any of the foregoing instances of isolated environments (e.g., isolated rendering environments, remote browser isolation environments, etc.) can comprise isolated environments enabled by third-party tools, isolated environments instantiated by a QR code filter (e.g., as virtual machine environments), isolated environments instantiated by custom web browsers or web browsers that support isolated environments as a mode or setting such as remote browser isolation environments, etc. Moreover, these isolated environments may be external to a web browser or client, e.g., in the cloud or as separate processes on a same device having different security permissions at that device.

The foregoing refers to both characteristics of a QR code and characteristics of a redirect web page to which a QR code redirects. The characteristics of a QR code can comprise characteristics of the redirect web page (e.g., malicious content and sensitive data detected therein) and/or characteristics of the initial web page that includes the QR code. Any of the foregoing analyses for determining whether a QR code is malicious using DLP analysis and security analysis also can be applied to analyzing the initial web page and a rendering of the initial web page. Characteristics of the initial web page resulting from this analysis can be included in the QR code characteristics when determining whether the QR code is malicious. The analysis of the initial web page can further involve generating and analyzing features that typically correlate with phishing attacks.

Any of the foregoing analysis that applies to renderings of web pages can alternatively be applied to HTTP responses that are used for those renderings. For instance, a script that is executed during rendering can alternatively be identified and analyzed in a corresponding HTTP response prior to rendering.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 406, 408, 410, and 412 can be performed in parallel or concurrently across sessions. With respect to FIG. 3 updating/maintaining a malicious QR code database is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

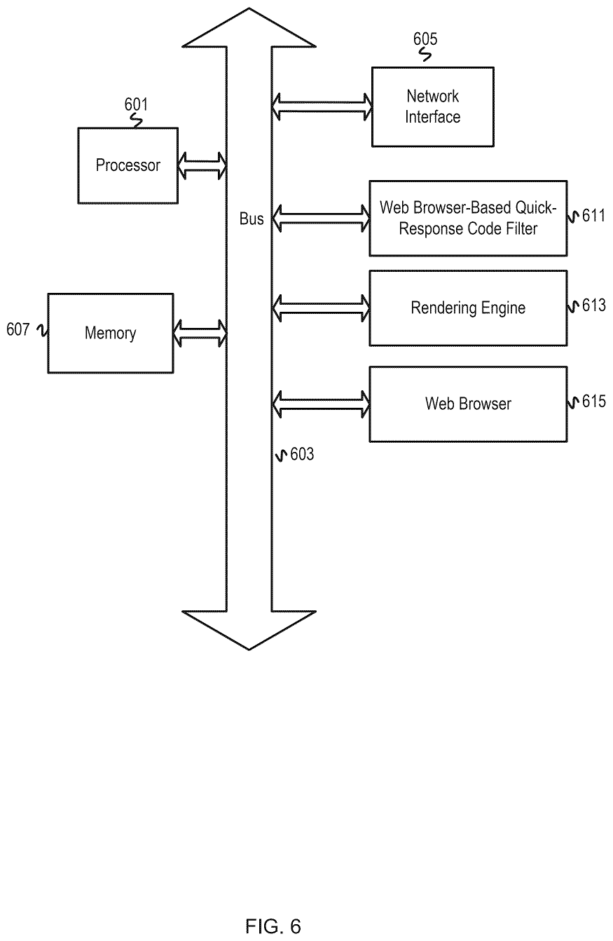

FIG. 6 depicts an example computer system with a web browser-based QR code filter, a rendering engine, and a web browser. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a web browser-based QR code filter (QR code filter) 611, a rendering engine 613, and a web browser 615. The QR code filter 611 scans HTTP responses intended for the web browser 615 for QR codes and, based on detecting a QR code in an initial web page, decodes the QR code to identify a redirect web page where the QR code redirects. The rendering engine 613 then renders the redirect web page and any additional web pages redirected from the redirect web page in an isolated environment. The QR code filter 611 analyzes the QR code for maliciousness based on the renderings obtained from the rendering engine 613 as well as additional characteristics of the QR code obtained during the rendering. The QR code filter 611 determines any remediation action(s) to perform based on the maliciousness analysis, and the web browser 615 renders the initial web page after any remediation action(s) is performed. The additional characteristics include any associated attack types, severities, sensitive data types, etc. The QR code filter 611 determines a remediation action(s) to perform based on the characteristics of the QR code that are subsequently performed by the QR code filter 611 and/or the web browser 615 prior to and during rendering of the initial web page. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
intercepting a Hypertext Transfer Protocol (HTTP) response of a first web page intended for a web browser;
prior to communicating the HTTP response to the web browser, detecting a quick-response (QR) code in the first web page, wherein detecting the QR code comprises,
scanning the HTTP response to identify image data; and
detecting the QR code from the image data;
decoding the QR code to identify a second web page to which the QR code redirects;
obtaining characteristics of at least one of the first web page and the second web page; and
determining whether the QR code is malicious based, at least in part, on the characteristics of the first web page and the second web page.

2. The method of claim 1, wherein obtaining characteristics of the second web page comprises rendering the second web page in an isolated environment.

3. The method of claim 2, wherein rendering the second web page in the isolated environment comprises rendering the second web page and one or more additional web pages to which the second web page redirects in the isolated environment.

4. The method of claim 2, wherein the characteristics of the second web page comprise at least one of attempted uploads, attempted downloads, and attempted script executions that occurred during rendering of the second web page in the isolated environment.

5. The method of claim 1, further comprising, based on determining that the QR code is malicious, at least one of reporting the QR code as malicious and blocking the QR code from further access by the web browser.

6. The method of claim 1, wherein the characteristics of the second web page comprise a uniform resource locator (URL) of the second web page, wherein determining whether the QR code is malicious comprises determining whether the URL of the second web page is malicious.

7. The method of claim 1, further comprising replacing the QR code with a uniform resource locator of the first web page.

8. The method of claim 1, further comprising, based on determining that the QR code is malicious, at least one of,
masking the QR code in first web page; and
based on the web browser receiving a request for the second web page, rendering the second web page in a remote browser isolation environment.

9. The method of claim 1, further comprising:
determining that the QR code is benign, wherein determining that the QR code is benign comprises,
determining that the second web page does not comprise sensitive data; and
determining that the second web page and/or a uniform resource locator of the second web page have a security score below a threshold security score; and
based on determining that the QR code is benign, rendering the first web page in the web browser.

10. A non-transitory machine-readable medium having program code stored thereon, the program code comprising instructions to:
obtain a Hypertext Transfer Protocol (HTTP) response for a first web page intended for a web browser;
determine whether the HTTP response comprises a quick-response (QR) code;
based on a determination that the HTTP response comprises the QR code, suspend a session corresponding to the HTTP response;
identify a second web page to which the QR code redirects;
analyze characteristics of at least one of the second web page and the first web page to determine whether the QR code is malicious; and
based on a determination that the QR code is malicious,
perform one or more in-browser remediation actions for at least the first web page; and
resume the session corresponding to the HTTP response.

11. The machine-readable medium of claim 10, wherein the program code further comprises instructions to, based on a determination that the QR code is benign,
render the first web page in the web browser; and
resume the session corresponding to the HTTP response.

12. The machine-readable medium of claim 10, wherein the instructions to perform the one or more in-browser remediation actions for at least the first web page comprise instructions to at least one of,
remove the QR code from the first web page;
display at least one of a warning and a preview of the second web page in the first web page;
replace the QR code with a uniform resource locator of the second web page;
force the web browser to render the second web page in an isolated environment; and
mask the QR code in the first web page.

13. The machine-readable medium of claim 10, wherein the program code further comprises instructions to render the second web page in an isolated environment to obtain the characteristics of the second web page.

14. The machine-readable medium of claim 10, wherein the instructions to analyze the characteristics of at least one of the second web page and the first web page to determine whether the QR code is malicious comprise instructions to analyze the characteristics of at least one of the second web page and the first web page using data loss prevention analysis and security analysis.

15. The machine-readable medium of claim 10, wherein the program code further comprises instructions to,
determine a severity of risk associated with the QR code based, at least in part, on the characteristics of at least one of the second web page and the first web page; and
choose the one or more in-browser remediation actions to perform based, at least in part, on the determined severity.

16. An apparatus comprising:
a processor; and
a machine-readable medium having instructions stored thereon that are executable by the processor to cause the apparatus to,
scan Hypertext Transfer Protocol (HTTP) responses intended for a web browser to detect quick-response (QR) codes; and
based on detecting a QR code in a first web page corresponding to an HTTP response in the HTTP responses,
suspend a session corresponding to the HTTP response until resolution of the QR code;
decode the QR code to identify a second web page to which the QR code redirects;
analyze characteristics of the QR code for sensitive data and security exposure to determine whether the QR code is malicious, wherein the characteristics of the QR code comprise at least one of characteristics of the first web page and characteristics of the second web page; and
based on a determination that the QR code is malicious, perform one or more in-browser remediation actions.

17. The apparatus of claim 16, wherein the machine-readable medium further has stored thereon instructions executable by the processor to cause the apparatus to, subsequent to the instructions executable by the processor to cause the apparatus to perform the one or more in-browser remediation actions, resume the session corresponding to the HTTP response.

18. The apparatus of claim 16, wherein the machine-readable medium further has stored thereon instructions executable by the processor to cause the apparatus to render the second web page in an isolated environment to obtain the characteristics of the second web page.

19. The apparatus of claim 18, wherein the instructions to render the second web page in the isolated environment comprise instructions executable by the processor to cause the apparatus to render the second web page and one or more additional web pages to which the second web page redirects in the isolated environment.

20. The apparatus of claim 16, wherein the instructions to perform one or more in-browser remediation actions for at least the first web page comprise executable by the processor to cause the apparatus to at least one of, remove the QR code from the first web page;
display at least one of a warning and a preview of the second web page in the first web page;
replace the QR code with a uniform resource locator of the second web page;
force the web browser to render the second web page in an isolated environment; and
mask the QR code in the first web page.
